(19) United States
(12) Patent Application Publication
(10) Pub. No.: US 2025/0378637 A1
(43) Pub. Date: Dec. 11, 2025

(54) ROOM-SPECIFIC GEOMETRIC REPRESENTATIONS

(71) Applicant: Apple Inc., Cupertino, CA (US)

(72) Inventors: Kyle L Simek, San Jose, CA (US); Ming Chuang, Bellevue, WA (US); Giulio Marin, Los Altos, CA (US); Antti P. Saarinen, Jarvenpaa (FI); Nikolaus Demmel, Munich (DE); Yao Lu, Sunnyvale, CA (US); Oliver T. Ruepp, Baierbrunn (DE); Tobias Böttger-Brill, Muenchen (DE); Aitor Aldoma Buchaca, Munich (DE); Divya Ramakrishnan, Los Altos, CA (US); Praveen Gowda Ippadi Veerabhadre Gowda, San Jose, CA (US)

(21) Appl. No.: 19/226,014

(22) Filed: Jun. 2, 2025

Related U.S. Application Data
(60) Provisional application No. 63/657,625, filed on Jun. 7, 2024.

(51) Int. Cl. G06T 17/00; G06T 7/13

(52) U.S. Cl. CPC G06T 17/00; G06T 7/13; G06T 2207/10028

(57) ABSTRACT

Various implementations provide one or more geometric representations of a physical environment based on room-specific subsets of the sensor data. For example, a method may include obtaining sensor data of a physical environment that includes a plurality of rooms, and the sensor data includes images of the physical environment. The method may further include obtaining room boundary information associated with the physical environment, wherein the room boundary information is determined based on the sensor data. The method may further include identifying room-specific subsets of the sensor data based on the room boundary information. The method may further include generating one or more geometric representations of the physical environment based on the room-specific subsets of the sensor data.

### CROSS-REFERENCE TO RELATED APPLICATIONS

This application claims the benefit of U.S. Provisional Application Ser. No. 63/657,625 filed Jun. 7, 2024, which is incorporated herein in its entirety.

### TECHNICAL FIELD

The present disclosure generally re lates to electronic devices that use sensors to scan physical environments to generate geometric representations of the scanned physical environments.

### BACKGROUND

Existing active/passive scanning systems and techniques may be improved with respect to assessing and using the sensor data obtained during scanning processes to generate three-dimensional (3D) representations such as 3D floor plans representing physical environments.

### SUMMARY

Various implementations disclosed herein include devices, systems, and methods that provide room-specific use of sensor data for use in three-dimensional (3D) reconstruction and/or understanding of a physical environment around a user (e.g., meshes and/or plane generation for use in multi-room 3D floor plans). For example, room-specific meshes and/or planes may be formed by generating multiple geometric representations (e.g., multiple meshes and/or multiple planes) of a large environment and taking into account identified room boundaries. Given such room boundaries, captured data (e.g., keyframes of image and/or depth data) may be selectively used to generate the geometric representations, e.g., only those keyframes that correspond to a given room may be used to update the 3D meshes of that room. These techniques may be generic to any form of room scanning, such as passive scanning performed during simultaneous localization and mapping (SLAM), to reconstruct/understand the physical environment (not just for floor plan generation). In some implementations, parts of a SLAM map may be updated based on which room the user is in, and portions of the SLAM map only associated with the room in which the user is in can be passed to apps, etc.

In some implementations, these room-specific process may be used with generating other parametric primitives (e.g., spheres, cylinders, and the like), or implicit representations such as NeRFs/Gaussian-Splatting. In some implementations, individual objects may be represented in a scene with a suitable presentation (e.g., a wall with a plane, a pillar with a cylinder, a more general object with a mesh or an implicit representation, and the like). In other words, other representations may also be linked to and/or limited to a specific room or bounded area similar to the meshes and/or plane generation for use in multi-room 3D floor plans as described herein.

In some implementations, keyframes may be selected that are appropriate for each room and may be clustered together and fed into a meshing process. Additionally, keyframe clustering may improve meshing efficiency and accuracy for generating 3D representations of a physical environment (e.g., 3D floorplans). For example, with respect to the alignment of walls, avoiding collisions of walls, avoiding one room's mesh being influenced by details in an adjacent room, help when there are mirrors, coping with simultaneous localization and mapping (SLAM) drift, improve the appearance of openings between rooms, and/or addressing thin structure issues such as walls (e.g., sometimes walls would disappear), may be improved with keyframe clustering. Moreover, in contrast to meshes being generated for smaller segments that could span multiple rooms, meshes may be clustered by room so that each room is associated with one or more meshes, where a mesh does not span multiple rooms. A plane may span multiple rooms (e.g., floor, ceiling, shared wall, etc.), but will similarly be generated using captured data corresponding to only the one or more rooms in which it occurs.

Various implementations disclosed herein may further include devices, systems, and methods that provide association of meshes and/or planes with rooms, e.g., for use in multi-room 3D floor plans to be utilized while viewing extended reality (XR) environments. For example, a process for association of meshes and/or planes may include enabling a function in XR that selectively uses a subset of geometric representations (e.g., meshes and/or planes) of a large environment based on the geometric representations being associated with particular rooms. For example, a room may be associated with one or more meshes, and a plane may span multiple rooms but will only be associated with rooms in which the plane is found. The association of meshes and/or planes with rooms may be used by an operating system level function that uses the room-specific meshes/planes, or it may be a third-party application that tells the system which room it is in and receives the room-specific meshes/planes for its own function (e.g., limit the information associated with the room-specific meshes/planes for a particular application).

Various implementations disclosed herein may further include devices, systems, and methods that provide an application with limited access to sensor-based physical environment information (e.g., data about plane, meshes, virtual object placements, etc.). The access may be limited based on associating sensor-based environment information with respective keyframes (e.g., sets of image/other data obtained from particular positions/poses). The device may associate pieces of sensor-based environment information (e.g., planes, meshes, virtual object placements) with the respective keyframe from which each piece of information was determined. For example, plane A is associated with keyframe-1 based on determining that keyframe-1 was used to identify plane A, plane B is associated with keyframe-2 based on determining that keyframe-2 was used to identify plane B, etc.

In some implementations, once a user provides permission for an application to have access to sensor-based environment information, the application is given access to specific information to preserve the privacy of the user. In some implementations, the specification information may be associated with a keyframe that is relevant to the applications' position(s) during use of the application (e.g., during the current application run session and/or prior application run sessions). Specifically, as an application is used, only some of the keyframes known to the device are relevant for the device's positions while the application is being run (e.g., keyframes from nearby positions that are used for SLAM and/or to evaluate the proximate environment, such as to identify planes, meshes, etc.). In the above example, if the application was not used in a location where keyframe-2 was relevant, then it will not have access to plane B information. The application may only have access to sensor-based environment information associated with these keyframes, which has the effect of only giving the application access to information “visible” to the device during use of the application.

In some implementations, the system may provide central handling and accumulation of privacy data across multiple features (e.g., meshes, planes, etc.). In some implementations, the system may provide persistence of privacy data per application (e.g., extending the visibility of privacy data beyond the current session so a device has access to all information in previously had access to in prior sessions. In some implementations, the system may provide a unique way of using keyframes as privacy entities, providing a novel way of grouping sets of sensor-based data where the grouping facilitates limited distribution to applications in a privacy-preserving way, e.g., so that the applications aren't provided access to information associated with portions of an environment that are not visible during use of the application.

In general, one innovative aspect of the subject matter described in this specification can be embodied in methods, at an electronic device having a processor, that include the actions of obtaining sensor data of a physical environment that includes a plurality of rooms, the sensor data including images of the physical environment. The actions further include obtaining room boundary information associated with the physical environment, where the room boundary information is determined based on the sensor data. The actions further include identifying room-specific subsets of the sensor data based on the room boundary information. The actions further include generating one or more geometric representations of the physical environment based on the room-specific subsets of the sensor data.

These and other embodiments can each optionally include one or more of the following features.

In some aspects, identifying room-specific subsets of the sensor data based on the room boundary information includes identifying a set of room-specific keyframes for each room of the plurality of rooms. In some aspects, the sensor data includes first sensor data obtained for a first period of time, the method further including the actions of obtaining second sensor data for a second period of time, wherein the second sensor data corresponds to a first room of the plurality of rooms, and in response to obtaining the second sensor data, updating the set of room-specific keyframes for the first room of the plurality of rooms.

In some aspects, the actions may further include updating a three-dimensional (3D) representation for the first room based on the updated set of room-specific keyframes. In some aspects, the actions may further include determining a set of planes associated with each room of the plurality of rooms based on the room-specific subsets of the sensor data.

In some aspects, determining the set of planes for each room includes identifying a floor plane, a ceiling plane, and a wall plane for at least one or more walls of each room.

In some aspects, the actions may further include generating a three-dimensional (3D) representation of the physical environment based on the one or more geometric representations. In some aspects, the actions may further include presenting a live view of the 3D representation on a display of the electronic device.

In some aspects, the live view of the room includes a floorplan that is produced while obtaining the sensor data. In some aspects, the images of the physical environment are based on at least one of live view images, ultra-wide view images that include a different view than the live view images, and semantically-labeled images corresponding to the live view images or the ultra-wide view images.

In some aspects, the room boundary information is determined based on 3D semantic data that includes a 3D point cloud that includes semantic labels associated with at least a portion of 3D points within the 3D point cloud. In some aspects, the semantic labels identify walls, wall structures, objects, and classifications of the objects of each room.

In general, one innovative aspect of the subject matter described in this specification can be embodied in methods, at an electronic device having a processor, that include the actions of identifying a room of a multi-room physical environment in which the electronic device is operating, where geometric representations are associated with rooms of the multi-room physical environment. The actions may include obtaining a room-specific subset of the geometric representations, wherein the room-specific subset of the geometric representations is identified based on identifying which of the geometric representations is associated with the room. The actions may include providing a view of an extended reality (XR) environment that depicts virtual content and the room of the multi-room physical environment, wherein the virtual content is provided based on executing a function using the room-specific subset of the geometric representations.

These and other embodiments can each optionally include one or more of the following features.

In some aspects, identifying the room of the multi-room physical environment is based on tracking a location of the electronic device. In some aspects, identifying the room of the multi-room physical environment is based on localization of the electronic device with respect to a corresponding floorplan associated with the multi-room physical environment.

In some aspects, the actions may further include selectively providing the room-specific subset of the geometric representations to an application on the electronic device. In some aspects, the virtual content is not visible from the view of the XR environment when the electronic device moves to another room.

In general, one innovative aspect of the subject matter described in this specification can be embodied in methods, at an electronic device having a processor, that include the actions of associating sets of sensor data-based environment information with respective keyframes of a collection keyframes associated with a physical environment. The actions may include identifying a subset of the collection of keyframes corresponding to use of an application in the physical environment. The actions may include identifying a subset of the sets of sensor data-based environment information based on the subset of the collection of keyframes. The actions may include providing the application with limited access to the sets of sensor data-based environment information, where the limited access is limited to the subset of the sets of sensor-data based environment information

These and other embodiments can each optionally include one or more of the following features.

In some aspects, associating the sets of sensor data-based environment information with respective keyframes comprises associating a first keyframe with a first plane based on an identification of the first plane using the first keyframe and associating a second keyframe with a second plane based on an identification of the second plane using the second keyframe. In some aspects, associating the sets of sensor data-based environment information with respective keyframes comprises associating a first keyframe with a first mesh based on an identification of the first mesh using the first keyframe and associating a second keyframe with a second mesh based on an identification of the second mesh using the second keyframe.

In some aspects, associating the sets of sensor data-based environment information with respective keyframes is based on identifying room-specific subsets associated with the physical environment. In some aspects, the subset of the sets of sensor data-based environment information is based on room boundary information associated with the physical environment.

In some aspects, identifying the subset of the collection of keyframes corresponding to the use of the application in the physical environment is based on identifying keyframes of the collection keyframes based on a location of the device. In some aspects, identifying the subset of the collection of keyframes corresponding to the use of the application in the physical environment is based on identifying keyframes of the collection keyframes based on a pose of the device.

In accordance with some implementations, a device includes one or more processors, a non-transitory memory, and one or more programs; the one or more programs are stored in the non-transitory memory and configured to be executed by the one or more processors and the one or more programs include instructions for performing or causing performance of any of the methods described herein. In accordance with some implementations, a non-transitory computer readable storage medium has stored therein instructions, which, when executed by one or more processors of a device, cause the device to perform or cause performance of any of the methods described herein. In accordance with some implementations, a device includes: one or more processors, a non-transitory memory, and means for performing or causing performance of any of the methods described herein.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIGS. 1A-B illustrate a physical environment in accordance with some implementations.

FIG. 2 illustrates a portion of a 3D point cloud representing the first room of FIGS. 1A-B in accordance with some implementations.

FIG. 3 illustrates a portion of a first 3D floor plan representing the first room of FIGS. 1A-B, in accordance with some implementations.

FIG. 4 is a view of the 3D floor plan of FIG. 3.

FIG. 5 is another view of the 3D floor plan of FIGS. 3 and 4.

FIG. 6 is a view of a second 3D floor plan of a second room.

FIG. 7 is a view of a combined 3D floor plan that combines the first 3D floor plan of FIGS. 3-5 with the second 3D floor plan of FIG. 6 in accordance with some implementations.

FIGS. 8A-I illustrate an exemplary multi-room 3D floor plan process in accordance with some implementations.

FIGS. 9A-D illustrate an exemplary process for generating multiple geometric representations for a floor plan in accordance with some implementations.

FIGS. 10A-B illustrate an exemplary room-specific subset identification process for geometric representations of a floor plan in accordance with some implementations.

FIG. 11 is flowchart illustrating an exemplary 3D room plan generation pipeline based on keyframes in accordance with some implementations.

FIG. 12 is a flowchart illustrating a method for improving a combined 3D floor plan in accordance with some implementations.

FIG. 13 is a flowchart illustrating a method for generating room-specific geometric representations in accordance with some implementations.

FIG. 14 is a flowchart illustrating a method for providing a view of an extended reality (XR) environment based on room-specific geometric representations in accordance with some implementations.

FIG. 15 is a flowchart illustrating a method for limiting access to sets of sensor data-based environment information in accordance with some implementations.

FIG. 16 is a block diagram of an electronic device in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices and circuits have not been described in exhaustive detail so as not to obscure more pertinent aspects of the example implementations described herein.

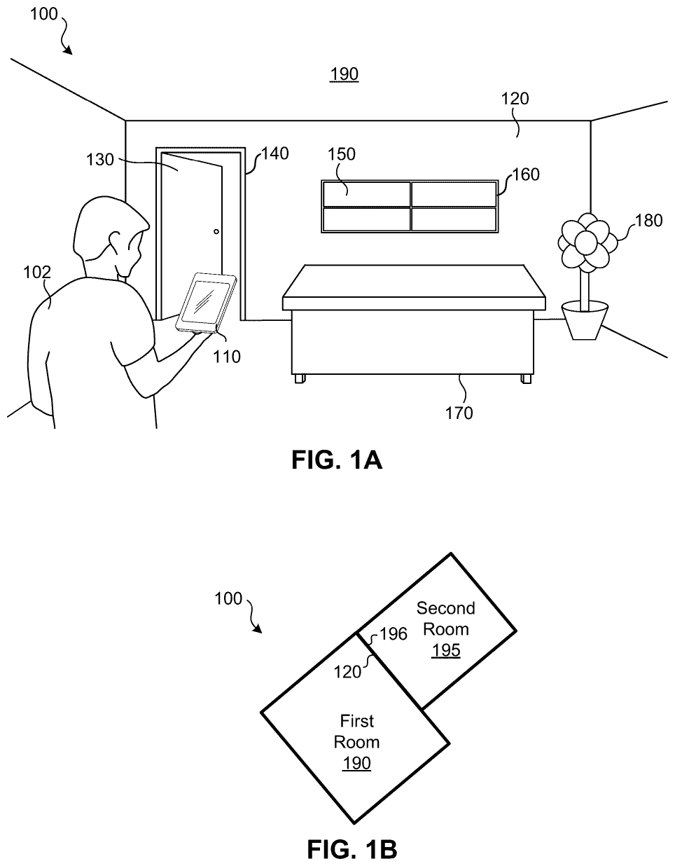

FIGS. 1A-B illustrate an exemplary physical environment 100. In this example, FIG. 1A illustrates an exemplary electronic device 110 operating in a first room 190 of the physical environment 100. In this example of FIG. 1A, the first room 190 includes a door 130 (providing an opening leading to a second room 195 of the physical environment 100), a door frame 140, and a window 150 (with window frame 160) on wall 120. The first room 190 also includes a desk 170 and a potted plant 180. As illustrated in the top-down view of FIG. 1B, the first room 190 and second room 195 abut one another, i.e., a portion of the wall 120 of the first room 190 abuts (e.g., is the opposite side of) the wall 196 of the second room 195.

The electronic device 110 includes one or more cameras, microphones, depth sensors, motion sensors, or other sensors that can be used to capture information about and evaluate the physical environment 100. The obtained sensor data may be used to generate a 3D representation, such as a 3D point cloud, a 3D mesh, or a 3D floor plan.

In one example, the user 102 moves around the physical environment 100 and device 110 captures sensor data from which one or more 3D floor plans of the physical environment 100 are generated. The device 110 may be moved to capture sensor data from different viewpoints, e.g., at various distances, viewing angles, heights, etc. The device 110 may provide information to the user 102 that facilitates the environment scanning process. For example, the device 110 may provide a view from a camera showing the content of RGB images currently being captured, e.g., a live camera feed, during the room scanning process. As another example, the device 110 may provide a view of a live 3D point cloud or a live 3D floor plan to facilitate the scanning process or otherwise provides feedback that informs the user 102 of which portions of the physical environment 100 have already been captured in sensor data and which portions of the physical environment 100 require more sensor data in order to be represented accurately in a 3D representation and/or 3D floor plan.

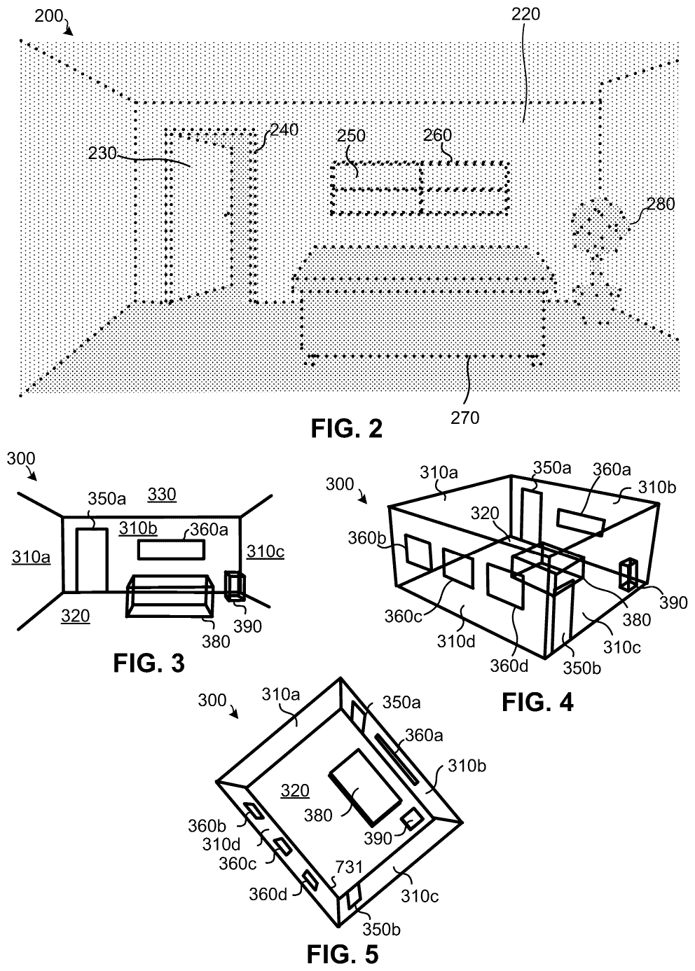

The device 110 performs a scan of the first room 190 to capture data from which a first 3D floor plan 300 (FIG. 3-5) of the first room 190 is generated. In this process, for example, a dense point-based representation, such as a 3D point cloud 200 (FIG. 2), may be generated to represent the first room 190 and used to generate the first 3D floor plan 300, which may represent the 3D positions of the walls, wall openings, windows, doors, and objects of the first room 190. In some implementations, a 3D floor plan defines the positions of such elements using non-point cloud data such as one or more parametric representations. For example, such a parametric representation may define 2D/3D shapes (e.g., primitives) that represent the positions and sizes of elements of a room in the 3D floor plan. In some implementations, a 3D floor plan of a room, such as the first room 190, is generated based on a 3D point cloud that is generated during a first scan of the first room 190, e.g., a scan captured as user 102 walks around the first room 190 capturing sensor data.

FIG. 2 illustrates a portion of a 3D point cloud representing the first room 190 of FIGS. 1A-B. In some implementations, the 3D point cloud 200 is generated based on one or more images (e.g., greyscale, RGB, etc.), one or more depth images, and motion data regarding movement of the device in between different image captures. In some implementations, an initial 3D point cloud is generated based on sensor data and then the initial 3D point cloud is densified via an algorithm, machine learning model, or other process that adds additional points to the 3D point cloud. The 3D point cloud 200 may include information identifying 3D coordinates of points in a 3D coordinate system. Each of the points may be associated with characteristic information, e.g., identifying a color of the point based on the color of the corresponding portion of an object or surface in the physical environment 100, a surface normal direction based on the surface normal direction of the corresponding portion of the object or surface in the physical environment 100, a semantic label identifying the type of object with which the point is associated, an estimated type of material, and the like.

In alternative implementations, a 3D mesh is generated in which points of the 3D mesh have 3D coordinates such that groups of the mesh points identify surface portions, e.g., triangles, corresponding to surfaces of the first room 190 of the physical environment 100. Such points and/or associated shapes (e.g., triangles) may be associated with color, surface normal directions, semantic labels, and/or estimated materials.

In the example of FIG. 2, the 3D point cloud 200 includes a set of points 220 representing wall 120, a set of points 230 representing door 130, a set of points 240 representing the door frame 140, a set of points 250 representing the window 150, a set of points 260 representing the window frame 160, a set of points 270 representing the desk 170, and a set of points 280 representing the potted plant 180. In this example, the points of the 3D point cloud 200 are depicted with relative uniformity and with points on object edges emphasized to facilitate easier understanding of the figures. However, it should be understood that the 3D point cloud 200 need not include uniformly distributed points and need not include points representing object edges that are emphasized or otherwise different than other points of the 3D point cloud 200.

The 3D point cloud 200 may be used to identify one or more boundaries and/or regions (e.g., walls, floors, ceilings, etc.) within the first room 190 of the physical environment 100. The relative positions of these surfaces may be determined relative to the physical environment 100 and/or the 3D point-based representation 200. In some implementations, a plane detection algorithm, machine learning model, or other technique is performed using sensor data and/or a 3D point-based representation (such as 3D point cloud 200). The plane detection algorithm may detect the 3D positions in a 3D coordinate system of one or more planes of physical environment 100. The detected planes may be defined by one or more boundaries, corners, or other 3D spatial parameters. The detected planes may be associated with one or more types of features, e.g., wall, ceiling, floor, table-top, counter-top, cabinet front, etc., and/or may be semantically labelled. Detected planes associated with certain features (e.g., walls, floors, ceilings, etc.) may be analyzed with respect to whether such planes include windows, doors, and openings. Similarly, the 3D point cloud 200 may be used to identify any representation of an object. For example, the 3D point cloud 200 may be used to identify one or more boundaries of an object, identify bounding boxes around an object (e.g., bounding boxes corresponding to desk 170 and plant 180), and the like.

The 3D point cloud 200 is used to generate a first 3D representation of the physical environment, such as a first floor plan 300 illustrated in FIGS. 3-5, representing the first room 190 of the physical environment 100 of FIGS. 1A-B. For example, detected planes, boundaries, bounding boxes, etc. may be detected and used to generate shapes (e.g., 2D/3D primitives) that represent the elements of the first room 190 of the physical environment 100. In FIGS. 3-5, wall representations 310a-d represent the walls of the first room 190 (e.g., wall representation 310b represents wall 120), floor representation 320 represents the floor 320 of the first room 190, door representations 350a-b represent the doors of the first room 190 (e.g., door representation 350a represents door 130), window representations 360a-d represent the windows of the first room 190 (e.g., window representation 360a represents window 150), desk representation 380 is a bounding box representing desk 170 and flowers representation 290 is a bounding box representing potted plant 180. In this example, since the 3D floor plan includes object representations for non-room-boundaries, e.g., for 3D objects within the room such as desk 170 and potted plant 180, the 3D floor plan may be considered a 3D room scan. In other implementations, a 3D floor plan represents only room boundary features, e.g., walls, floor, doors, windows, etc.

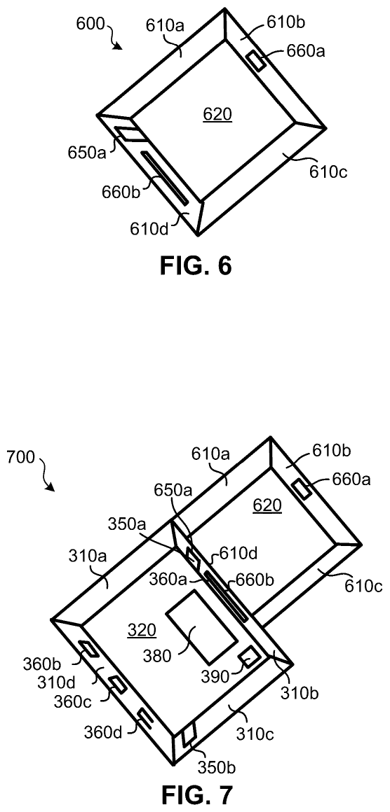

A similar (but distinct) scanning process is used to generate a second 3D representation of the physical environment, such as a second floor plan 600 illustrated in FIG. 6, of a second room 195 of the physical environment 100 of FIGS. 1A-B. Such a second scan may be based on sensor data obtained within the second room 195. For example, detected planes, boundaries, bounding boxes, etc. may be detected and used to generate shapes, e.g., 2D/3D primitives that represent the elements of the second room 195 of the physical environment 100. In FIG. 6, wall representations 610a-d represent the walls of the second room 195, floor representation 620 represents the floor of the second room 195, door representation 650a represents the door of the second room 195, and window representations 660a-b represent the windows of the second room 195.

As described, the first 3D floor plan 300 of FIGS. 3-5 and the second 3D floor plan 600 of FIG. 6 are generated by a first and second room scan, respectively. Such room scans may be distinct or non-contiguous such that device motion tracking between scans is unavailable, inaccurate, or otherwise not available for use in accurately positionally associating the distinct 3D floor plans. Implementations disclosed herein address such lack of positional association by determining positional associations between multiple, distinct 3D floor plans using various techniques.

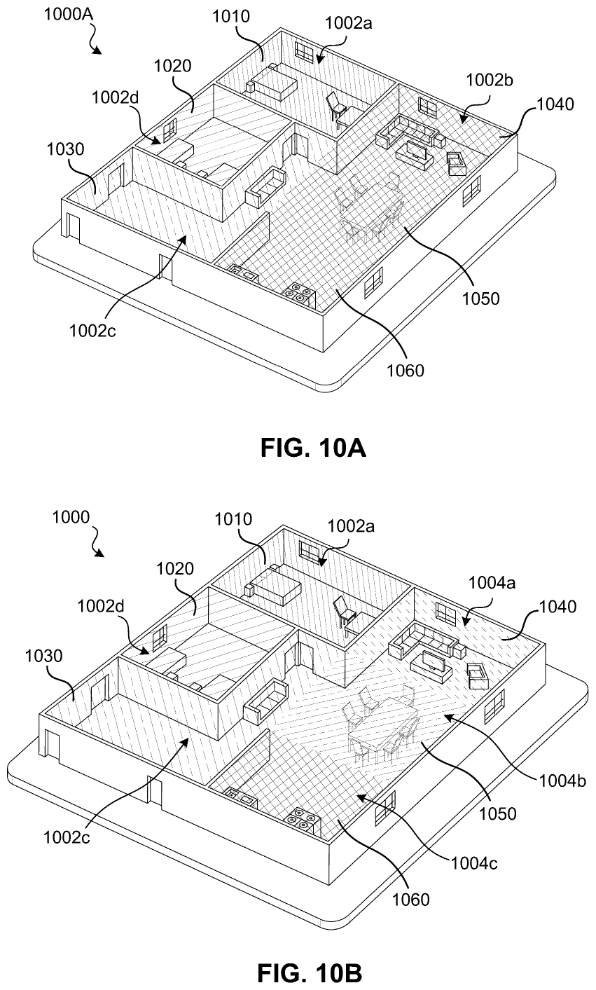

Given a determined positional relationship between multiple, distinct 3D floor plans, the 3D floor plans can be combined (e.g., stitched together into a single representation) to form a single, combined 3D floor plan. FIG. 7 is a view of a combined 3D floor plan 700 that combines the first 3D floor plan 300 of FIGS. 3-5 with the second 3D floor plan of FIG. 6. As illustrated, the 3D floor plans 300, 600 are positioned adjacent to one another and aligned with one another in ways that accurately correspond to the positional relationship between the first and second rooms 190, 195 that the 3D floor plans 300, 600 represent. For example, the floors of the first room 190 and second room 195 may be level with one another in the physical environment 100 and thus the floor representations 320, 620 may be level (on the same plane) with one another in the combined 3D floor plan 700. As another example, wall representation 310b (corresponding to wall 120) and wall representation 610d (corresponding to wall 196) may abut one another based on the walls 120, 196 being two sides of the same wall in physical environment 100. In some implementations such abutting walls are merged into a single wall (e.g., as described with respect to FIG. 10). Similarly, walls, doors and door openings, windows and window openings, other openings, and other features may be accurately aligned or otherwise positioned based on an accurate positional relationship between the distinct 3D floor plans 300, 600. In the case of merged walls, doors, windows, etc. from the merged walls may be projected onto the merged walls to provide an accurate and aligned appearance.

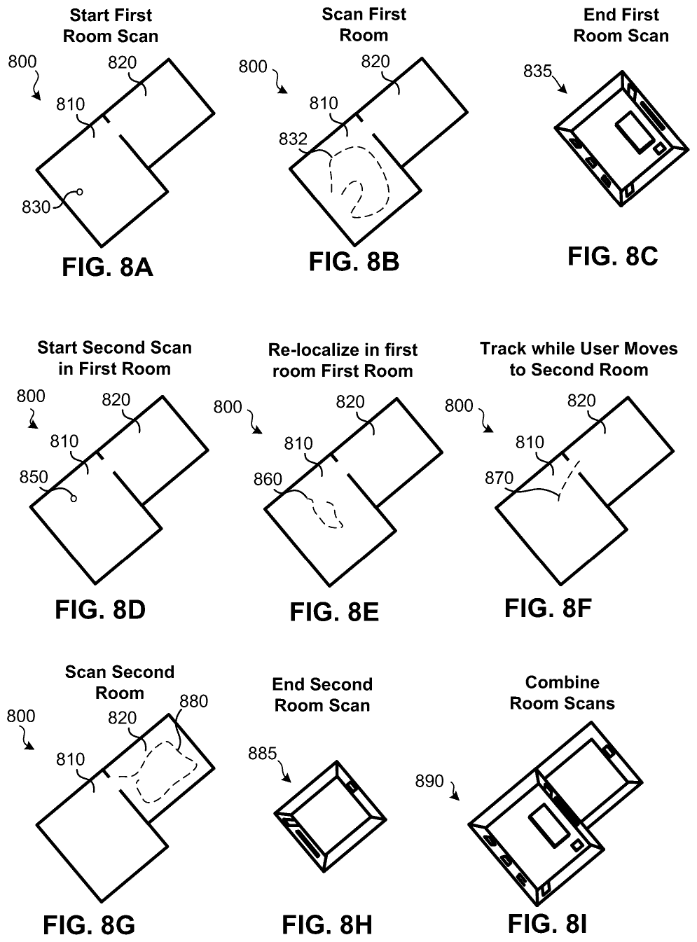

FIGS. 8A-I illustrate an exemplary multi-room 3D floor plan process. In this example, as illustrated in FIG. 8A, a user initiates a first scan from a starting position 830 within a first room 810 of a physical environment 800. As illustrated in FIG. 8B, during the first scan, the user walks along path 832 capturing images of various portions of the first room 810. As illustrated in FIG. 8B, at some point after the end of this first scan, a first 3D floor plan 835 is generated. At this point, the user need not continue scanning and the device need not track its position. The user may (or may not) take a break or otherwise wait (e.g., waiting a minute, hour, day, hour, week, month, etc.) before performing a second scan. FIGS. 8A-I illustrate an exemplary multi-room 3D floor plan process that includes a user scanning one room at a time, however, in some implementations, the scanning process may be a continuous process, where the system may keep updating each room as a user traverses the different rooms (e.g., updating multiple rooms at a time).

As illustrated in FIG. 8D, the user initiates the second scan in the first room 810 of the physical environment 800 from position 850. As illustrated in FIG. 8E, during this initial portion of the second scan, the device re-localizes within the first room 810, for example, by capturing sensor data as the user moves about (e.g., along path 860) within the first room. The re-localization may involve matching features in sensor data captured during the first scan with sensor data captured during the second scan's initial portion, both of which are based on data captures within the first room 810. Feature points detected in 2D images of the second scan, for example, can be mapped with respect to 3D locations of those features points that were determined based on localization performed based on the sensor data from the first scan. In some implementations, a simultaneous localization and mapping (SLAM) technique is used to re-localize during the second scan based on data from the first scan.

In some implementations, a user interface guides the user to start the second scan in a previously-scanned room (e.g., in the first room 810), guides the user to obtain re-localization data (e.g., by walking around or moving the device to capture sensor data of the previously-scanned room), and/or notifies the user once localization is complete, e.g., with guidance to move to a second room to generate a second 3D floor plan of the second room.

As illustrated in FIG. 8F, the device tracks the user moving (e.g., walking) from the first room 810 to the second room 820 of the physical environment 800 along path 870. Tracking the device motion may be based on motion sensor (e.g., accelerometer, gyroscope, etc.) data and/or visual inertial odometry (VIO) and/or other image-based motion tracking. Tracking via motion sensor, VIO, etc. may be continuous as the user moves the device from the first room 810 to the second room 820. The tracking may involve determining whether a user is changing floor/stories within a building, e.g., by detecting a staircase, that the user is traversing the staircase, whether the user is going up or down the staircase, the height of the staircase, etc. based on sensor data. For example, images and/or depth data may be captured and used to determine that the device is moving from a ground floor to a basement or vice versa.

The re-localization and subsequent tracking of movement from the first room 810 to the second room 820 provides data than enables determining a positional relationship between the 3D floor plans generated from the first and second scans.

As illustrated in FIG. 8G, the second room 820 is scanned after the user has re-localized (FIG. 8E) and moved to the second room 820 (FIG. 8F). In some implementations, the device automatically detects that the device is capturing data for a new room (i.e., different than the first room 810) and automatically starts capturing scan data for use in generating the 3D floor plan of the second room 820. This may occur during the movement along path 870 (e.g., while the user is still in the first room 810 or after the user has entered the second room 820). In some implementations, the user provides input to start the capturing of the scan data for use in generating the 3D floor plan of the second room 820. During the scan of the second room 820 the user may capture sensor data of the second room 820, for example, as the user moves along path 880. As illustrated in FIG. 8H, at some point after the end of this second scan, a second 3D floor plan 885 is generated. The re-localization and subsequent tracking of movement from the first room 810 to the second room 820 provides localization data than enables a determining a positional relationship between the 3D floor plans generated from the first and second scans. This positional relationship is used, as illustrated in FIG. 8I, to generate a combined 3D floor plan 890 in which the first 3D floor plan 835 and second 3D floor plan 885 are combined in a positionally accurate way. An optimization process may be used to combine the rooms in a way that reduces or minimizes artifacts and/or errors, e.g., alignment imperfections between aligned walls, corners, door, windows, doors, hallway walls not appearing parallel, door/door opening/windows not lining up precisely, etc.

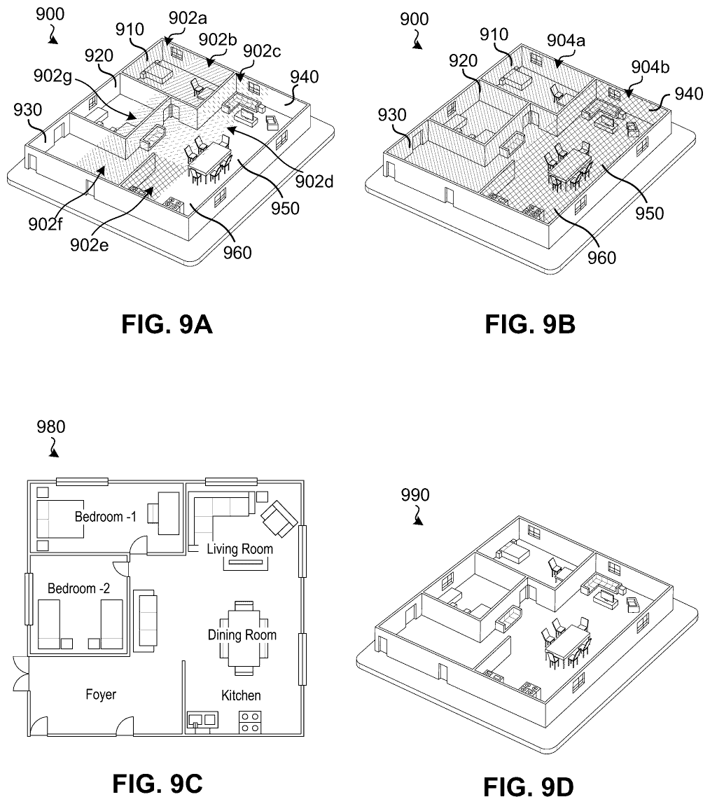

FIGS. 9A-9D illustrate an exemplary process for generating multiple geometric representations for a floor plan in accordance with some implementations. As illustrated in FIG. 9A, during a scan of a representation 900 of a physical environment (e.g., as illustrated in FIGS. 8A-I), different geometric representations (e.g., 3D meshes) may be generated. For example, geometric representations 902a,b appear to include all of, or at least most of, bedroom-1 910, geometric representation 902g covers a portion of bedroom-2 920, geometric representation 902c covers a portion of living room 940, geometric representation 902d covers a portion of dining room 950, geometric representation 902e covers a portion of kitchen 960, and geometric representation 902f covers a portion of foyer 930. FIG. 9B illustrates detecting larger size 2D meshes for particular physical structures that encompass multiple rooms, such as a floor or a ceiling. For example, geometric representation 904a,b may represent two 2D planes for the ceiling of the representation 900. During a scan of an environment, and/or after completing an entire scan of a physical environment, a 2D floorplan 980 as illustrated in FIG. 9C and/or a 3D floorplan 990 as illustrated in FIG. 9D may be generated. In some implementations, the 2D floorplan 980 and/or the 3D floorplan 990 may be used by applications on a device. Additionally, in some implementations, the 2D floorplan 980 and/or the 3D floorplan 990 may be provided to a user performing the scan as a preview while being generated or after being generated.

FIGS. 10A-10B illustrate an exemplary room-specific subset identification process for geometric representations of a floor plan in accordance with some implementations. In particular, FIGS. 10A,B illustrate 3D floorplan representations 1000A,B, respectively, for obtaining room boundary information from a scan of a physical environment (e.g., representation 900) and selectively identifying room-specific subsets of the geometric representations. In other words, assigning different geometric representations (e.g., 3D mesh regions) to specific rooms based on room plan algorithms that may obtain sensor data and determine semantic data, planes, object detection/bounding boxes, identified room structures (walls, opening, window, door, etc.), and the like, to identify each room or area.

As illustrated in FIG. 10A, the 3D floorplan representation 1000A includes geometric representation 1002a that is associated with bedroom-1 1010, geometric representation 1002d that is associated with bedroom-2 1020, geometric representation 1002b that is associated with living room 1040, dining room 1050, and kitchen 1060, and geometric representation 1002c that is associated with the foyer 1030. Thus, because the living room 1040, dining room 1050, and kitchen 1060 are all one large open area, the geometric representation 1002b is one large 3D mesh representation for that area/room. However, as illustrated in FIG. 10B, the 3D floorplan representation 1000B is based on determining that the living room 1040, the dining room 1050, and the kitchen 1060 should be separated by different geometric representation 1004a,b,c, respectively. For example, geometric representations may be segmented space based on a “function” of an area. In other words, the system may not need to identify a thin structure (e.g., a wall) to technically define a room separate from another room. The identification of splitting an area into two rooms or segments may be automatically determined, based on user feedback/interaction, or based on a semantic understanding of the objects in the rooms (e.g., can identify kitchen area based on cabinets, island with a stovetop etc.).

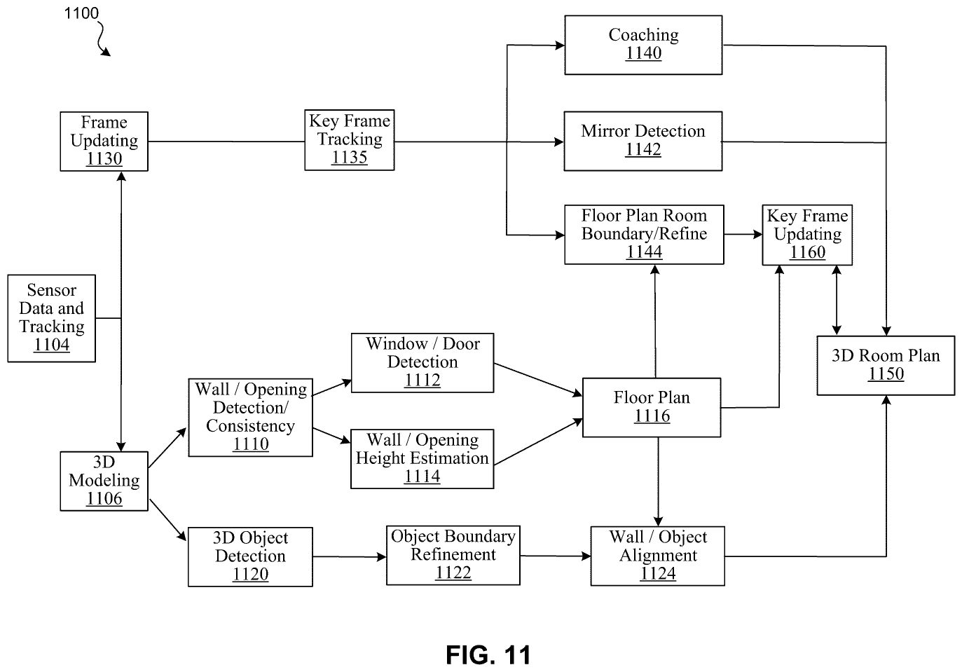

FIG. 11 is flow chart illustrating an exemplary 3D room plan generation pipeline 1100, which may be executed at a device such as device 110 of FIG. 1. In this pipeline 1100, sensor data is obtained at sensor data and tracking block 1104. Such sensor data may include captured images, depth sensor data, ambient light sensor data, motion sensor data and/or any other type of sensor data useful in scanning, providing, feedback, and/or 3D room scan generation. At sensor data and tracking block 1104, the device may track its pose (i.e., position and/or orientation) as the device captures the sensor data. Data from the sensor data and tracking block 1104 is used at 3D modeling block 1106.

The 3D modeling block 1106 may use the sensor data (e.g., during the scanning of the physical environment) to generate and update a 3D model (e.g., a 3D point cloud or 3D mesh) representing the physical environment. As more and more sensor data is received and processed, the 3D model may be refined and updated. Such updating may occur live during the scanning process and/or after the scanning process concludes. The 3D modeling block 1106 may provide a 3D model that includes points or mesh polygons that correspond to surface portions of the physical environment. Such points and/or mesh polygons may each have a 3D position and be associated with additional information including, but not limited to, color information, surface normal information, semantic label information, and estimated material, e.g., identifying the type of object each point or mesh polygon corresponds. The color, surface normal, semantic, and estimated material information may be determined based on evaluating the sensor data, for example, using an algorithm or machine learning model. The 3D modeling block 1106 may provide a 3D model to the wall/opening detection and consistency block 1110 and/or to the 3D object detection block 1120. The 3D model that is provided to block 1110, 1120 may be updated over time, e.g., during the capturing of sensor data during scanning process and/or after the scanning process.

The wall/opening detection and consistency block 1110 uses the 3D model to detect walls and openings within the physical environment. This may involve predicting planar surfaces corresponding to walls, floors, ceilings, etc. and/or boundaries of such planar surfaces. In some implementations, a machine learning model evaluates the 3D model and/or sensor data to identify planar surfaces and/or to detect the walls, openings, etc. This may involve using positional and additional information associated with points/mesh polygons of the 3D model. For example, this may involve using the positions, colors, surface normal, estimated material, and/or semantics associated with the points/mesh polygons of the 3D point cloud or 3D mesh.

The wall/opening detection and consistency block 1110 uses the detected walls, openings, etc. and compares them with other data to ensure that the positioning, sizes, shapes, etc. of the walls, openings, etc. are consistent with one another. The wall/opening detection and consistency block 1110 provides the adjusted walls, openings, etc. to the window/door detection block 1112 and the wall/opening height estimation block 1114.

The window/door detection block 1112 detects windows and doors on the walls. Such detection may utilize the 3D model from block 1106, sensor data from block 1104, and/or data about the walls, openings, etc. from block 1110. In some implementations, the window/door detection block 1112 detects points/mesh polygons of the 3D model that are within a threshold distance of a detected wall, opening, etc. and associates those points/mesh polygon vertices with the wall. For example, this may involve projecting some point cloud points onto the plane of the wall. Windows, doors, etc. may be detected based on the projected points with or without semantic information. In some implementations, an algorithm or machine learning model interprets the 3D model and detected walls, openings, etc. to predict the locations and sizes of windows, doors, etc.

The wall/opening height estimation block 1114 estimates the heights of walls and openings. Such detection may utilize the 3D model from block 1106, sensor data from block 1104, and/or data about the walls, openings, etc. from block 1110. Such detection may include the use of an algorithm or machine learning model.

The output of blocks 1112, 1114 is used to produce floor plan 1116 that specifies the locations and sizes of elements of the physical environment that are approximately planar/architectural, e.g., walls, floors, ceilings, openings, windows, doors, etc. Such a 3D floor plan may represent the planar elements of the physical environment parametrically, e.g., by specifying positions of two or more points that provide sufficient information to form a rectangle, polygon, or other 2D shape, e.g., opposing corner points defining a rectangles shape and position within a 3D coordinate system. In some implementations, approximately planar/architectural, e.g., walls, floors, ceilings, openings, windows, doors, etc. have some thickness and are represented, for example, using parameters that specify a 2D shape and a thickness.

The 3D model from block 1106 is also output to 3D object detection block 1120. The 3D object detection block 1120 may detect objects such as tables, televisions, screens, refrigerators, fireplaces, shelves, ovens, chairs, stairs, sofas, dishwashers, cabinets, stoves, beds, toilets, washers, dryers, sinks, bathtubs, etc. Such detection may utilize the 3D model from block 1106 and/or sensor data from block 1104. Such detection may include the use of an algorithm or machine learning model. In some implementations, a machine learning model evaluates the 3D model and/or sensor data to identify bounding boxes or other primitive shapes around 3D objects. This may involve using positional and additional information associated with points/mesh polygons of the 3D model. For example, this may involve using the positions, colors, surface normal, estimated material, and/or semantics associated with the points/mesh polygons of the 3D point cloud or 3D mesh. As a specific example, a group of points corresponding to a table type object may be identified based on the semantic labels associated with the points of a point cloud. A bounding box around these points may be determined based on the location of the points. Such a bounding box may be oriented based on surface normal of the points, e.g., so that the bounding box orientation matches the orientation of the table.

At the object boundary refinement block 1122 the boundaries of 3D objects detected at block 1120 are refined. Such refinement may utilize the 3D model from block 1106, sensor data from block 1104, the 3D objects detected at block 1120. The sensor data from block 1140 may include frame updates from block 1130, e.g., sensor data associated images that are used to provide a live preview during the scan, semantically-labeled images, etc. The frame updates from block 1130 may then be analyzed at block 1135 for keyframe tracking. For example, keyframes may be tracked and used for a resulting 3D mesh of one or more portions of a 3D floor plan. In some implementations, the keyframes may be selected that are appropriate for a room and may be clustered together and fed into a meshing process. Additionally, keyframe clustering may improve meshing efficiency and accuracy for generating 3D representations of a physical environment (e.g., 3D floorplans) by utilizing clustering techniques for efficient feature extraction methods.

In some implementations, block 1135 for keyframe tracking may include associating sensor-based environment information with respective keyframes (e.g., sets of image/other data obtained from particular positions/poses). For example, a device may associate pieces of sensor-based environment information (e.g., planes, meshes, virtual object placements) with a respective keyframe from which each piece of information was determined. For example, plane A is associated with keyframe-1 based on determining that keyframe-1 was used to identify plane A, plane B is associated with keyframe-2 based on determining that keyframe-2 was used to identify plane B, etc.

In some implementations, once a user provides permission for an application to have access to sensor-based environment information, the application is given access to only privacy information that is associated with a keyframe that is relevant to the app's position(s) during use of the application (e.g., during the current application run session and/or prior application run sessions). Specifically, as an application is used, only some of the keyframes known to the device are relevant for the device's positions while the application is being run (e.g., keyframes from nearby positions that are used for SLAM and/or to evaluate the proximate environment, e.g., to identify planes, meshes, etc.). In the above example, if the application was not used in a location where keyframe-2 was relevant, then it will not have access to plane B information. The application may only have access to sensor-based environment information associated with these keyframes, which has the effect of only giving the application access to information “visible” to the device during use of the application.

Additionally, the refinements may be used by coaching block 1140 or otherwise to provide feedback to the user by adjusting the locations of object representations (e.g., bounding box edges) that may not line up precisely with corresponding real-world edges depicted in live image data. Thus, in some implementations, the refinements may be used to display edge indications over a live view during the scan. In some implementations, such refinements are used only for live view augmentation during scanning. In some implementations, such refinements are used only to improve the 3D object representations for use in generating the 3D room plan. In some implementations, such refinements are used for both. The unrefined and/or refined 3D objects may be provided to wall/object alignment block 1124.

The wall/object alignment block 1124 adjusts the 3D object representations (e.g., the 3D bounding box representations) based on floor plan 1116. For example, a 3D bounding box for table located close to a wall may be adjusted to be parallel to the wall, against the wall, etc. In some implementations, 3D objects representations that are within a threshold distance of a wall of the floor plan 1116 are automatically adjusted to be aligned with the wall.

The output of wall/object alignment block 1124 provides bounding boxes or other 3D primitive representations of 3D objects for use in generating the 3D room plan 1150.

The 3D primitive representation may represent a 3D object parametrically, e.g., by specifying positions of two or more vertices that provide sufficient information to form a 3D box, cone, cylinder, wedge, sphere, torus, pyramid, etc., e.g., opposing corner points defining a 3D box's shape and position within a 3D coordinate system.

The sensor data and tracking block 1104 also provides data used by frame updating block 1130. Frame updating block 1130 includes 2D frame data captured in the physical environment during the scan. It may include frame-based data (e.g., 2D images, 2D depth images, semantically-labelled 2D image, etc.) that is captured at a relatively fast rate during the scan. The frame data may be updated at a rate that is faster than the updating of the 3D model at 3D modeling block 1106. Frame updating block 1130 provides 2D frame data to the coaching block 1140, mirror detection block 1142, and floor plan room boundary refinement block 1144.

Coaching block 1140 may provide guidance or other information during the scanning process to facilitate the scanning process. For example, it may provide a live view of image data being captured, e.g., via pass through video, identify how the user should move the device to capture data for yet-to-be captured portions of the physical environment, guide the user to take actions to improve the quality of the image capture, e.g., to move more slowly, rescan an area, move to scan a new area, increase ambient lighting, etc.

Mirror detection block 1142 uses the 2D frame data from frame updating block 1130 to detect mirrors in the physical environment. Mirror detection may involve an algorithm or machine learning process configured to detect reflective surfaces within the physical environment. The mirror detection block 1142 may provide information about detected mirror that is used to generate the 3D room plan 1150.

The floor plan room boundary refinement block 1144 uses the 2D frame data from frame updating block 1130 and the floor plan 1116 to determine room boundaries and/or refinements to the floor plan. For example, after receiving the keyframes from block 1135 the floor plan room boundary refinement block 1144 may identify room-specific boundaries (e.g., planes associated with a room), generate rough boundaries (e.g., low level estimation), and use that information to generate meshes/planes for each identified room, before applying refinements. The information associated with the room-specific meshes/planes for each identified room may then be sent to the keyframe updating block 1160.

The keyframe updating block 1160 may select, track, and update keyframes that are appropriate for each room and may be clustered together and fed into a meshing process. Additionally, keyframe clustering may improve meshing efficiency and accuracy for generating 3D representations of a physical environment (e.g., 3D floorplans). For example, with respect to the alignment of walls, avoiding collisions of walls, avoiding one room's mesh being influenced by details in an adjacent room, help when there are mirrors, coping with simultaneous localization and mapping (SLAM) drift, improve the appearance of openings between rooms, and/or addressing thin structure issues such as walls (e.g., sometimes walls would disappear), may be improved with keyframe clustering. Moreover, in contrast to meshes being generated for smaller segments that could span multiple rooms, meshes may be clustered by room so that each room is associated with one or more meshes, where a mesh does not span multiple rooms. This room-specific mesh/plane information may then be utilized by the 3D room plan block 1150.

The keyframe updating block 1160 may update a collection of keyframes associated with a physical environment (e.g., all the keyframes the device has for the house). The keyframe updating block 1160 may update the associated sensor-based environment information with respective keyframes. For example, the device may updated the associated pieces of sensor-based environment information (e.g., planes, meshes, virtual object placements, etc.) with the respective keyframe from which each piece of information was determined.

In some implementations, the refinements for the floor plan room boundary refinement block 1144 may be used by coaching block 1140 or otherwise to provide feedback to the user about the locations of wall edges and other boundaries determined for the floor plan 1116 that may not line up precisely with corresponding real-world edges depicted in live image data. Thus, in some implementations, the refinements of the floor plan may be used to display edge indications over a live view during the scan. The floor plan boundary refinement may involve using 2D RGB images, 2D semantically-labelled images, 2D depth data or other 2D data obtained or generated therefrom to determine adjustments to boundaries of walls, openings, windows, doors, etc. in the floor plan. In some implementations, such refinements are used only for providing augmentations to a live view during scanning. In some implementations, such refinements are used only to improve the floor plan 1116 that is used to generate the 3D room plan 1150. In some implementations, such refinements are used both.

The 3D room plan 1150 thus combines a floor plan 1116 having 2D shapes representing walls, openings, doors, windows, and other planar/architectural elements with 3D object representations from block 1124. It may additionally account for information from coaching block 1140 and mirror detection 1142. The resulting 3D room plan 1150 may be generated efficiently and accurately due to the relatively high-level/parametric representations. In some implementations, the 3D room plan 1150 is generated relatively quickly, e.g., during or shortly after the scanning of the physical environment and does not require significant waiting (e.g., minutes, hours, days, etc.) for significant manual modification or other post-processing procedures.

The use of parametric representations to define a 3D room plan 1150 may enable defining the 3D room plan 1150 using a simple, compact data set that can be efficiently stored, managed, rendered, modified, shared, transmitted, or otherwise used. Such a 3D room plan may provide significant advantages over a non-parametrically-defined 3D room plan such as a room plan utilize dense point clouds or 3D meshes having hundreds or thousands of vertices representing hundreds or thousands of triangular faces. A parametric representation may utilize 3D bounding shapes that are primitives to represent the shapes of tables, objects, appliances, etc. Such representations may significantly simplify details while still providing a 3D room plan that accurately models significant aspects of the room.

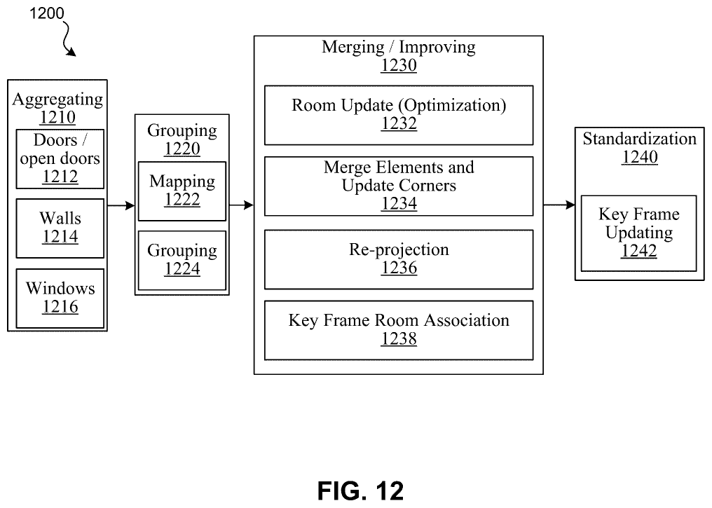

FIG. 12 is a flowchart illustrating a process 1200 for improving a combined 3D floor plan. In this example, elements of the combined 3D floor plans are aggregated and grouped as illustrated in aggregating block 1210 and grouping block 1220. Aggregating block 1210 identifies doors and door openings in block 1212, walls in block 1214, and windows in block 1216. Elements detected in multiple rooms that are spatially close together at mapping block 1222 and grouped together in grouping block 1224 are used to improve the combined 3D floor plan. For example, the mapping and grouping may identify that one wall is connecting/separating two rooms and one door is connecting those two rooms, and each of these groupings may be identified and used as a constraint in improving/optimizing the 3D floor plan at merging/improving block 1230.

Merging/Improving block 1230 performs a room update at block 1232, which may move or rotate the individual 3D floor plans relative to one another, e.g., to make walls parallel and/or perpendicular, hallways straight, etc. At block 1234 the process merges merge elements (e.g., planes representing adjacent walls). This may be based on the groupings from block 1220. Merging of wall planes may assume a wall thickness. For example, wall thickness may be based on the geographic location of the house, e.g., walls in a particular region may be expected to have a thickness of X inches, etc.

At block 1234 the process also updates corners of elements of adjacent rooms to align with one another. One or more optimization processes may be used. For example, such an optimization may use constraints from the groupings and iterative rotate and/or move each of the 3D floor plans to minimize error/distance measures. Each 3D floor plan may (or may not) be treated as a rigid body during such optimizations. Such optimizations may improve alignment and reduce erroneous gaps between adjacent 3D floor plan elements in the combined 3D floor plan.

At block 1236, wall elements (e.g., windows, doors, etc.) are reprojected onto any walls that were merged at block 1234. These elements may have (prior to the wall merging) been positioned on different planes and thus the merging may leave them “floating” in space. The wall elements (e.g., doors, windows, etc.) are reprojected onto the merged wall location can address this “floating” disconnected appearance. Reprojecting may involve calculating an orthographic projection onto the new merged wall position.

At block 1238, keyframes are selectively identified for each room or segment of a room of a floorplan (e.g., keyframe room association). For example, only those keyframes that correspond to a given room may be used to update the 3D meshes of that room. In some implementations, keyframes that are appropriated for each room may be clustered together and fed into a meshing process. For example, a limited set of all collected keyframes may be used for each identified room. In some implementations, at block 1238, the system may associate sensor-based environment information with respective keyframes (e.g., sets of image/other data obtained from particular positions/poses). For example, a device may associate pieces of sensor-based environment information (e.g., planes, meshes, virtual object placements) with a respective keyframe from which each piece of information was determined. For example, plane A is associated with keyframe-1 based on determining that keyframe-1 was used to identify plane A, plane B is associated with keyframe-2 based on determining that keyframe-2 was used to identify plane B, etc. In some implementations, once a user provides permission for an application to have access to sensor-based environment information, the application is given access to only privacy information that is associated with a keyframe that is relevant to the app's position(s) during use of the application (e.g., during the current application run session and/or prior application run sessions). Specifically, as an application is used, only some of the keyframes known to the device are relevant for the device's positions while the application is being run (e.g., keyframes from nearby positions that are used for SLAM and/or to evaluate the proximate environment, e.g., to identify planes, meshes, etc.). In the above example, if the application was not used in a location where keyframe-2 was relevant, then it will not have access to plane B information. The application may only have access to sensor-based environment information associated with these keyframes, which has the effect of only giving the application access to information “visible” to the device during use of the application.

At block 1240, a standardization process is executed to give the combined 3D floor plan a standardized appearance. The standardization process may include keyframe updating at block 1242. For example, keyframes may be tracked and used, along with the standardized data, to make revisions to the resulting 3D mesh of a 3D floor plan. Additionally, the respective keyframes that are associated to a corresponding use of an application in a physical environment may be updated (e.g., based on a current location and/or pose of the device).

The process 1200 may improve a combined 3D floor plan in various ways. The process 1200 may remove the appearance of double walls, align corners, and align other elements so that the combined 3D floor plan has an appearance that is accurate, easy to understand, and that is otherwise consistent with user expectations. Additionally, process 1200 may utilize room-specific subsets of sensor data (e.g., via keyframes) and limit such data to particular applications (e.g., limit an application to access the mesh associated with a bedroom but not an adjoining bathroom).

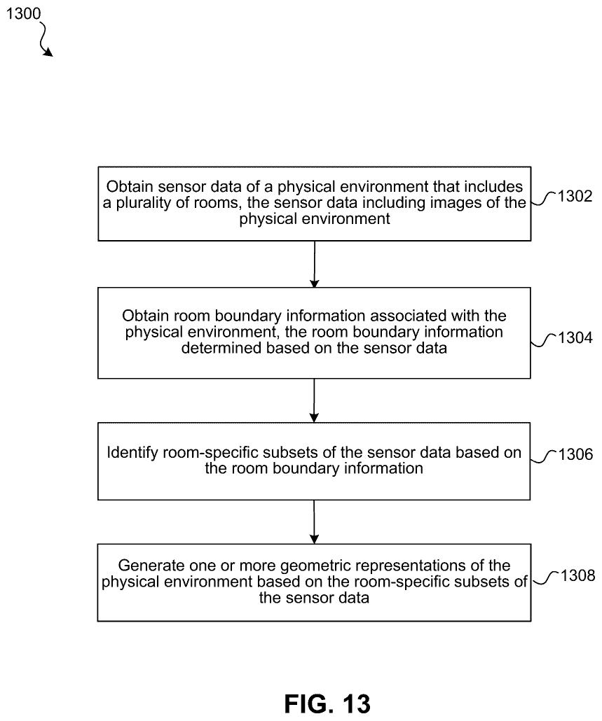

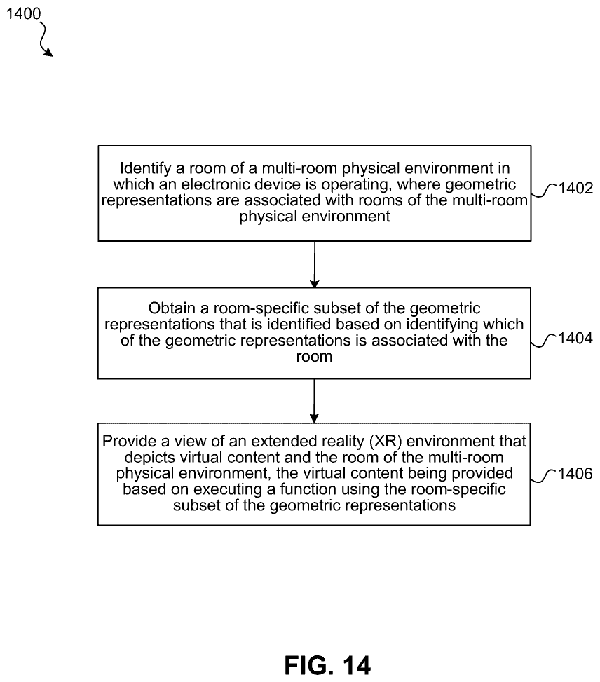

FIGS. 11 and 12 provide an example of how a room/mesh association may be used for generating a 3D floor plan. However, the techniques described herein, including, but not limited to, the method 1300 and method 1400 described below for FIGS. 13 and 14, respectively, may be used for different types of purposes other than generating a 3D floor plan (e.g., gaming, application placement, immersive experiences, and the like). Determining and using the room/mesh association may allow the application to only use the mesh/planes that's associated with the room that the user is in (resulting in more efficient processing), allow the system to show application windows that are only in the user's room, updating a SLAM map, allow an immersive environment to interact with only those portions of the meshes that are in the user's room, and the like. In other words, exemplary embodiments provide processes that identify mesh/planes associated with a room, and then perform some function/application using that known association, and the 3D room plan generation described in FIGS. 11 and 12 is one example of generating and using a mesh/room association. For example, the association of meshes and/or planes with rooms may be used by an operating system level function that uses the room-specific meshes/planes, or it may be a third-party application that tells the system which room it is in and receives the room-specific meshes/planes for its own function (e.g., limit the information associated with the room-specific meshes/planes for a particular application).

FIG. 13 is a flowchart illustrating a method 1300 for generating a 3D reconstruction of the physical environment where portions of the reconstructed environment are associated with respective rooms. In some implementations, a device such as electronic device 110 performs method 1300. In some implementations, method 1300 is performed on a mobile device, desktop, laptop, HMD, or server device. The method 1300 is performed by processing logic, including hardware, firmware, software, or a combination thereof. In some implementations, the method 1300 is performed on a processor executing code stored in a non-transitory computer-readable medium (e.g., a memory).

In various implementations disclosed herein, the method 1300 provides room-specific use of sensor data for use in three-dimensional (3D) reconstruction and/or understanding of a physical environment around a user (e.g., meshes and/or plane generation for use in multi-room 3D floor plans). For example, room-specific meshes and/or planes may be formed by generating multiple geometric representations (e.g., multiple meshes and/or multiple planes) of a large environment and taking into account identified room boundaries. Given such room boundaries, captured data (e.g., keyframes of image and/or depth data) may be selectively used to generate the geometric representations, e.g., only those keyframes that correspond to a given room may be used to update the 3D meshes of that room. The mesh/plane association may be used for different applications, such as generating a 3D floor plan, updating a SLAM map, gaming, immersive experiences, and the like.

At block 1302, the method 1300 obtains sensor data of a physical environment that includes a plurality of rooms, the sensor data including images of the physical environment. The sensor data may include a 3D point cloud and a sequence of 2D images corresponding to captured views of the room during the scan of the room. In some implementations, the sensor data includes image data (e.g., from an RGB camera), depth data (e.g., a depth image from a depth camera), ambient light sensor data (e.g., from an ambient light sensor), and/or motion data from one or more motion sensors (e.g., accelerometers, gyroscopes, etc.). The sensor data may include keyframes of the images.

In some implementations, the sensor data includes visual inertial odometry (VIO) data determined based on image data. The 3D point cloud may provide semantic information about one or more elements of the room. The 3D point cloud may provide information about the positions and appearance of surface portions within the physical environment. In some implementations, the 3D point cloud is obtained over time, e.g., during a scan of the room, and the 3D point cloud may be updated, and updated versions of the 3D point cloud obtained over time. For example, a 3D representation may be obtained (and analyzed/processed) as it is updated/adjusted over time (e.g., as the user scans a room, as illustrated in FIGS. 8A-I).

In some implementations, the 2D images correspond to a view that user may see during a live view. Alternatively, the 2D images that are captured during the scan of the room are an ultrawide image that is different than the live view shown to a user (e.g., additional sensor data is captured that is not displayed to the user during the scan). Additionally, in some implementations, the 2D images that are captured during the scan of the room include a semantically-labeled image corresponding to a live view and/or the ultra-wide view. In some implementations, there may be a passive scanning of the room (e.g., the user is doing something else with the device and the device is scanning the room behind the scenes without active user involvement).

At block 1304, the method 1300 obtains room boundary information associated with the physical environment, the room boundary information determined based on the sensor data. For example, room-specific meshes and/or planes may be formed by generating multiple geometric representations (e.g., multiple meshes and/or multiple planes) of a large environment and taking into account identified room boundaries.

In some implementations, the images of the physical environment are based on at least one of live view images, ultra-wide view images that include a different view than the live view images, and semantically-labeled images corresponding to the live view images or the ultra-wide view images. In some implementations, the room boundary information is determined based on 3D semantic data that includes a 3D point cloud that includes semantic labels associated with at least a portion of 3D points within the 3D point cloud. In some implementations, the semantic labels identify walls, wall structures, objects, and classifications of the objects of each room. In some implementations, the semantic labels may identify a type of room (e.g., living room, kitchen, bedroom, etc.).

At block 1306, the method 1300 identifies room-specific subsets of the sensor data based on the room boundary information. In other words, selectively identifying a limited number of keyframes for each room/segment. Given such room boundaries, captured data (e.g., keyframes of image and/or depth data) may be selectively used to generate the geometric representations, e.g., only those keyframes that correspond to a given room may be used to update the 3D meshes of that room. Additionally, or alternatively, in some implementations, room-specific subsets of the sensor data may be identified by matching/clustering keyframes with the same room type semantic labels (e.g., if the keyframes have room labels, such as semantically labeled rooms).

In some implementations, identifying room-specific subsets of the sensor data based on the room boundary information includes identifying a set of room-specific keyframes for each room of the plurality of rooms. For example, generating meshes for a given room, and only using keyframes for a given room. Keyframes may be captured for each room during a live scan or during use of a device. The keyframe process may compute clusters based on the sensor data (e.g., 3D point cloud), then keyframes are associated to rooms, rough boundaries are generated for a room (e.g., a low-level estimation), then this information is used to generate meshes/planes. A refinement module may refine the boundaries of the rough boundaries (room plane published) to provide a two-level approach, e.g., rough then refine.

In some implementations, if a keyframe is identified as being associated with two different rooms, then the keyframe may be selected for a particular room based on which keyframe is observing which room. For example, a system may look at each keyframe per room, score the keyframes, and determine which keyframes to process. Additionally, confidence levels may be determined and scored for each keyframe associated to each room. In some implementations, the system generates meshes for more than one room at a time, and then the system may clip part of the mesh that is identified as not part of the room.

In some implementations, the sensor data is first sensor data obtained for a first period of time, and the method 1300 further includes obtaining second sensor data for a second period of time, wherein the second sensor data corresponds to a first room of the plurality of rooms, and in response to obtaining the second sensor data, updating the set of room-specific keyframes for the first room of the plurality of rooms. In some implementations, the method 1300 further includes updating a three-dimensional (3D) representation for the first room based on the updated set of room-specific keyframes. For example, utilizing a keyframe clustering algorithm, keyframes may be appropriated for each room and are clustered together and fed into a meshing process. Keyframe clustering may improve meshing efficiency and accuracy for generating 3D representations of a physical environment (e.g., 3D floorplans). For example, with respect to the alignment of walls, avoiding collisions of walls, avoiding one room's mesh being influenced by details in an adjacent room, help when there are mirrors, coping with simultaneous localization and mapping (SLAM) drift, improve the appearance of openings between rooms, and/or addressing thin structure issues such as walls (e.g., sometimes walls would disappear), may be improved with keyframe clustering.

At block 1308, the method 1300 generates one or more geometric representations of the physical environment based on the room-specific subsets of the sensor data. For example, keyframes can be used to update an appropriate mesh corresponding to an appropriate room, e.g., a limited set of all collected keyframes is used for each room. Keyframe selection enables room-specific keyframe clustering for meshing (e.g., keyframes appropriate for each room are clustered together and fed into a meshing process). Plane generation/detection may also be based on room-specific subsets of sensor data.

In some implementations, the method 1300 further includes determining a set of planes associated with each room of the plurality of rooms based on the room-specific subsets of the sensor data. For example, plane generation and/or plane detection may also be based on room-specific subsets of sensor data (e.g., keyframes). In some implementations, determining the set of planes for each room includes identifying a floor plane, a ceiling plane, and a wall plane for at least one or more walls of each room.

In some implementations, the method 1300 further includes generating a 3D representation of the physical environment based on the one or more geometric representations. For example, define a room as a 3D bounded volume, but may not want to limit each geometric representation to a single definition. For example, the same open space may be two rooms, such as an open dining room to a kitchen. Thus, as discussed herein, geometric representations may be segmented space based on a “function” of an area. In other words, the system may not need to identify a thin structure (e.g., a wall) to technically define a room separate from another room. For example, a house with an open living room and dining room to a kitchen, or an office building with a corridor with several offices or cubicles. Thus, if there is a large space, the system may need to define some area(s) for segmentation. The defined areas may be a defined hierarchy of segmentation such as physical objects first (walls), then logical (corridor, cubicles, etc.). In some implementations, a process may involve manual input (e.g., interactions with representations) on a user interface to determine room designations for a geometric representation (e.g., splitting one large mesh into two rooms that do not have a wall between them, such as a kitchen and dining room area).

In some implementations, the method 1300 further includes presenting a live view of the 3D representation on a display of the electronic device. In some implementations, the live view of the room includes a floorplan that is produced while obtaining the sensor data. For example, generating a live view of the 3D mesh either as a preview while scanning an environment, or for an application on the device.

FIG. 14 is a flowchart illustrating a method 1400 for providing a view of an extended reality (XR) environment based on room-specific geometric representations. In some implementations, a device such as electronic device 110 performs method 1400. In some implementations, method 1400 is performed on a mobile device, desktop, laptop, HMD, or server device. The method 1400 is performed by processing logic, including hardware, firmware, software, or a combination thereof. In some implementations, the method 1400 is performed on a processor executing code stored in a non-transitory computer-readable medium (e.g., a memory).

In various implementations disclosed herein, the method 1400 provides association of meshes and/or planes with rooms, e.g., for use in multi-room 3D floor plans to be utilized while viewing XR environments. For example, a process for association of meshes and/or planes may include enabling a function in XR that selectively uses a subset of geometric representations (e.g., meshes and/or planes) of a large environment based on the geometric representations being associated with particular rooms. For example, a room may be associated with one or more meshes, and a plane may span multiple rooms but will only be associated with rooms in which the plane is found. The association of meshes and/or planes with rooms may be used by an operating system level function that uses the room-specific meshes/planes, or it may be a third-party application that tells the system which room it is in and receives the room-specific meshes/planes for its own function (e.g., limit the information associated with the room-specific meshes/planes for a particular application).

At block 1402, the method 1400 identifies a room of a multi-room physical environment in which the electronic device is operating, where geometric representations are associated with rooms of the multi-room physical environment. The geometric representations may include 2D/3D meshes and/or planes.

In some implementations, identifying the room of the multi-room physical environment is based on tracking a location of the electronic device. For example, the identification of a room of a multi-room physical environment (e.g., a bedroom of a house) may be the device's current room. In some implementations, identifying the room of the multi-room physical environment is based on localization of the electronic device with respect to a corresponding floorplan associated with the multi-room physical environment. For example, the identification of a room may be determined based on tracking device position, localization relative to a known floorplan/mapping, understanding/detection of semantic information of the objects in the room, or other techniques.

In some implementations, the room boundary information is associated with the physical environment and is determined based on obtaining sensor data. For example, room-specific meshes and/or planes may be formed by generates multiple geometric representations (e.g., multiple meshes and/or multiple planes) of a large environment and taking into account identified room boundaries. In some implementations, algorithms for 3D reconstruction of a physical environment may obtain sensor data and determine semantic data, planes, object detection/bounding boxes, identified room structures (walls, opening, window, door, etc.), and the like. In some implementations, the room boundary information is determined based on 3D semantic data that includes a 3D point cloud that includes semantic labels associated with at least a portion of 3D points within the 3D point cloud. In some implementations, the semantic labels identify walls, wall structures, objects, and classifications of the objects of each room.

At block 1404, the method 1400 obtaining a room-specific subset of the geometric representations that is identified based on identifying which of the geometric representations is associated with the room. For example, identifying only the meshes and planes associated with the current room. In other words, selectively identifying a limited number of keyframes for each room/segment. Given such room boundaries, captured data (e.g., keyframes of image and/or depth data) may be selectively used to generate the geometric representations, e.g., only those keyframes that correspond to a given room may be used to update the 3D meshes of that room.

In some implementations, identifying room-specific subsets of the sensor data based on the room boundary information includes identifying a set of room-specific keyframes for each room of the plurality of rooms. For example, generating meshes for a given room, and only using keyframes for a given room. Keyframes may be captured for each room during a live scan or during use of a device. The keyframe process may compute clusters, then keyframes are associated to rooms, rough boundaries are generated for a room (e.g., a low-level estimation), then this information is used to generate meshes/planes. A refinement module may refine the boundaries of the rough boundaries (room plane published) to provide a two-level approach, e.g., rough then refine.

In some implementations, if a keyframe is identified as being associated with two different rooms, then the keyframe may be selected for a particular room based on which keyframe is observing which room. For example, a system may look at each keyframe per room, score the keyframes, and determine which keyframes to process. Additionally, confidence levels may be determined and scored for each keyframe associated to each room.

At block 1406, the method 1400 provides a view of an XR environment that depicts virtual content and the room of the multi-room physical environment, the virtual content being provided based on executing a function using the room-specific subset of the geometric representations. For example, a process for association of meshes and/or planes may include enabling a function in XR that selectively uses a subset of geometric representations (e.g., meshes and/or planes) of a large environment based on the geometric representations being associated with particular rooms. For example, a room may be associated with one or more meshes, and a plane may span multiple rooms but will only be associated with rooms in which the plane is found.

In some implementations, the association of meshes and/or planes with rooms may be used by an operating system level function that uses the room-specific meshes/planes, or it may be a third-party application that tells the system which room it is in and receives the room-specific meshes/planes for its own function (e.g., limit the information associated with the room-specific meshes/planes for a particular application). For example, a house with an open living room and dining room to a kitchen, or an office building with a corridor with several offices or cubicles. Thus, if there is a large space, the system may need to define some area(s) for segmentation. The defined areas may be a defined hierarchy of segmentation such as physical objects first (walls), then logical (corridor, cubicles, etc.). In some implementations, a process may involve manual input (e.g., interactions with representations) on a user interface to determine room designations for a geometric representation (e.g., splitting one large mesh into two rooms that do not have a wall between them, such as a kitchen and dining room area).

In some implementations, the method 1400 further includes selectively providing the room-specific subset of the geometric representations to an application on the electronic device. For example, in order to provide better privacy management, the room-specific subset of the geometric representations (e.g., mesh data, plane data, etc.) may be limited to certain rooms for access to particular applications (e.g., not allowed to see in the bathroom).

In some implementations, the virtual content is not visible from the view of the XR environment when the electronic device moves to another room. For example, a virtual photo placed on a view of a physical wall may only be visible to a person standing in the room but would not be visible through a wall, and/or may not be visible to someone standing outside the room but looking into the room from outside the doorway or another open space.

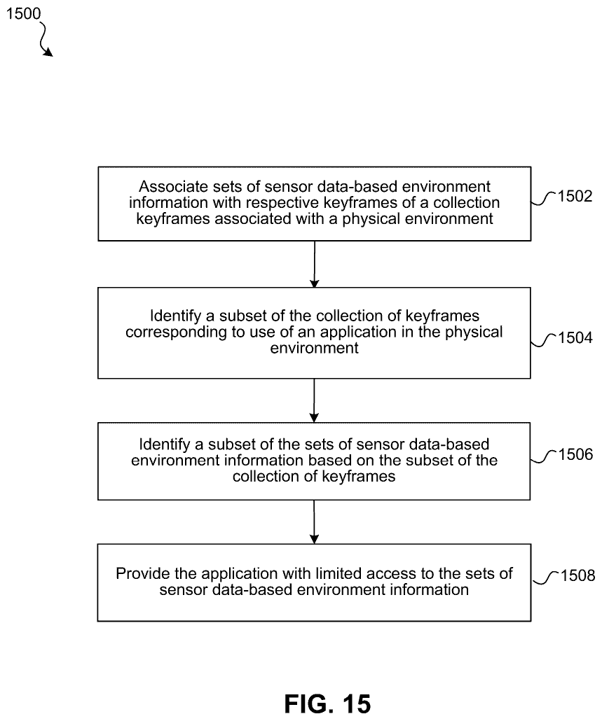

FIG. 15 is a flowchart illustrating a method 1500 for limiting access to sets of sensor data-based environment information. In some implementations, a device such as electronic device 110 performs method 1500. In some implementations, method 1500 is performed on a mobile device, desktop, laptop, HMD, or server device. The method 1500 is performed by processing logic, including hardware, firmware, software, or a combination thereof. In some implementations, the method 1500 is performed on a processor executing code stored in a non-transitory computer-readable medium (e.g., a memory).

In various implementations disclosed herein, the method 1500 provides an application with limited access to sensor-based physical environment information (e.g., data about plane, meshes, virtual object placements, etc.). The access may be limited based on associating sensor-based environment information with respective keyframes (e.g., sets of image/other data obtained from particular positions/poses). The device may associate pieces of sensor-based environment information (e.g., planes, meshes, virtual object placements) with the respective keyframe from which each piece of information was determined. For example, plane A is associated with keyframe-1 based on determining that keyframe-1 was used to identify plane A, plane B is associated with keyframe-2 based on determining that keyframe-2 was used to identify plane B, etc. In some implementations, once a user provides permission for an application to have access to sensor-based environment information, the application is given access to only privacy information that is associated with a keyframe that is relevant to the app's position(s) during use of the application (e.g., during the current application run session and/or prior application run sessions). Specifically, as an application is used, only some of the keyframes known to the device are relevant for the device's positions while the application is being run (e.g., keyframes from nearby positions that are used for SLAM and/or to evaluate the proximate environment, e.g., to identify planes, meshes, etc.). In the above example, if the application was not used in a location where keyframe-2 was relevant, then it will not have access to plane B information. The application may only have access to sensor-based environment information associated with these keyframes, which has the effect of only giving the application access to information “visible” to the device during use of the application.

At block 1502, the method 1500 associates sets of sensor data-based environment information with respective keyframes of a collection keyframes associated with a physical environment. For example, the collection keyframes may include all the keyframes the device has obtained or created for a particular house.

In some implementations, associating the sets of sensor data-based environment information with respective keyframes comprises associating a first keyframe with a first plane based on an identification of the first plane using the first keyframe and associating a second keyframe with a second plane based on an identification of the second plane using the second keyframe. For example, plane A is associated with keyframe-1 based on determining that keyframe-1 was used to identify plane A, plane B is associated with keyframe-2 based on determining that keyframe-2 was used to identify plane B, etc. In some implementations, associating the sets of sensor data-based environment information with respective keyframes comprises associating a first keyframe with a first mesh based on an identification of the first mesh using the first keyframe and associating a second keyframe with a second mesh based on an identification of the second mesh using the second keyframe.

In some implementations, the sets of sensor data-based environment information are determined based on obtaining sensor data of the physical environment via one or more sensors either at the device or obtained from another device. The sensor data may include images or depth data of the physical environment. The sensor data may include a 3D point cloud and a sequence of 2D images corresponding to captured views of the room during the scan of the room. In some implementations, the sensor data includes image data (e.g., from an RGB camera), depth data (e.g., a depth image from a depth camera), ambient light sensor data (e.g., from an ambient light sensor), and/or motion data from one or more motion sensors (e.g., accelerometers, gyroscopes, etc.). The sensor data may include keyframes of the images. In some implementations, the sensor data includes visual inertial odometry (VIO) data determined based on image data. The 3D point cloud may provide semantic information about one or more elements of the room. The 3D point cloud may provide information about the positions and appearance of surface portions within the physical environment. In some implementations, the 3D point cloud is obtained over time, e.g., during a scan of the room, and the 3D point cloud may be updated, and updated versions of the 3D point cloud obtained over time. For example, a 3D representation may be obtained (and analyzed/processed) as it is updated/adjusted over time (e.g., as the user scans a room, as illustrated in FIGS. 8A-I).

At block 1504, the method 1500 identifies a subset of the collection of keyframes corresponding to use of an application in the physical environment. For example, as an application is used, determining which of the keyframes known to the device are relevant for the device's positions while the app is being run. For example, identifying keyframes from nearby positions that are used for SLAM and/or to evaluate the proximate environment, e.g., to identify planes, meshes, and the like.

At block 1506, the method 1500 identifies a subset of the sets of sensor data-based environment information based on the subset of the collection of keyframes. For example, identifying the sensor data that is associated with the subset of keyframes that have been relevant to the applications use at prior locations in the environment.

At block 1508, the method 1500 provides the application with limited access to the sets of sensor data-based environment information. The limited access is limited to the subset of the sets of sensor-data based environment information. For example, the application only has access to information associated with the keyframes corresponding to use of the application, which has the effect of only giving the application access to information based on what is “visible” to the device during use of the application.

In some implementations, identifying the subset of the collection of keyframes corresponding to the use of the application in the physical environment is based on identifying keyframes of the collection keyframes based on a location of the device. Additionally, or alternatively, in some implementations, identifying the subset of the collection of keyframes corresponding to the use of the application in the physical environment is based on identifying keyframes of the collection keyframes based on a pose of the device.

In some implementations, associating the sets of sensor data-based environment information with respective keyframes is based on identifying room-specific subsets associated with the physical environment. In other words, selectively identifying a limited number of keyframes for each room/segment. Given such room boundaries, captured data (e.g., keyframes of image and/or depth data) may be selectively used to generate the geometric representations, e.g., only those keyframes that correspond to a given room may be used to update the 3D meshes of that room. Additionally, or alternatively, in some implementations, room-specific subsets of the sensor data may be identified by matching/clustering keyframes with the same room type semantic labels (e.g., if the keyframes have room labels, such as semantically labeled rooms). The room-specific subsets provides a representation of the privacy entities as keyframes. Some implementations are chunk based (e.g., 3×3×3 m blocks that either visible or not), but using the keyframe identification of a subset of the collection of keyframes corresponding to use of an application in the physical environment provides a more “room based” application for limiting the data provided to an application based on what is visible from the device's perspective.

In some implementations, identifying room-specific subsets of the sensor data based on the room boundary information includes identifying a set of room-specific keyframes for each room of the plurality of rooms. For example, generating meshes for a given room, and only using keyframes for a given room. Keyframes may be captured for each room during a live scan or during use of a device. The keyframe process may compute clusters based on the sensor data (e.g., 3D point cloud), then keyframes are associated to rooms, rough boundaries are generated for a room (e.g., a low-level estimation), then this information is used to generate meshes/planes. A refinement module may refine the boundaries of the rough boundaries (room plane published) to provide a two-level approach, e.g., rough then refine.

In some implementations, if a keyframe is identified as being associated with two different rooms, then the keyframe may be selected for a particular room based on which keyframe is observing which room. For example, a system may look at each keyframe per room, score the keyframes, and determine which keyframes to process. Additionally, confidence levels may be determined and scored for each keyframe associated to each room. In some implementations, the system generates meshes for more than one room at a time, and then the system may clip part of the mesh that is identified as not part of the room.

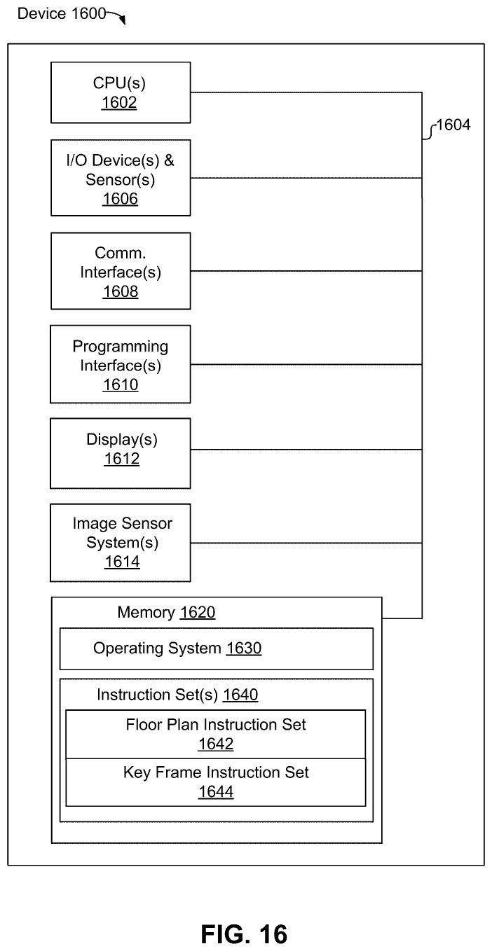

FIG. 16 is a block diagram of electronic device 1600. Device 1600 illustrates an exemplary device configuration for electronic device 110. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the device 1600 includes one or more processing units 1602 (e.g., microprocessors, ASICs, FPGAs, GPUs, CPUs, processing cores, and/or the like), one or more input/output (I/O) devices and sensors 1606, one or more communication interfaces 1608 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, SPI, 12C, and/or the like type interface), one or more programming (e.g., I/O) interfaces 1610, one or more output device(s) 1612, one or more interior and/or exterior facing image sensor systems 1614, a memory 1620, and one or more communication buses 1604 for interconnecting these and various other components.

In some implementations, the one or more communication buses 1604 include circuitry that interconnects and controls communications between system components. In some implementations, the one or more I/O devices and sensors 1606 include at least one of an inertial measurement unit (IMU), an accelerometer, a magnetometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some implementations, the one or more output device(s) 1612 include one or more displays configured to present a view of a 3D environment to the user. In some implementations, the one or more output devices 1612 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electromechanical system (MEMS), and/or the like display types. In some implementations, the one or more displays correspond to diffractive, reflective, polarized, holographic, etc. waveguide displays. In one example, the device 1600 includes a single display. In another example, the device 1600 includes a display for each eye of the user.

In some implementations, the one or more output device(s) 1612 include one or more audio producing devices. In some implementations, the one or more output device(s) 1612 include one or more speakers, surround sound speakers, speaker-arrays, or headphones that are used to produce spatialized sound, e.g., 3D audio effects. Such devices may virtually place sound sources in a 3D environment, including behind, above, or below one or more listeners. The one or more output device(s) 1612 may additionally or alternatively be configured to generate haptics.

In some implementations, the one or more image sensor systems 1614 are configured to obtain image data that corresponds to at least a portion of a physical environment. For example, the one or more image sensor systems 1614 may include one or more RGB cameras (e.g., with a complimentary metal-oxide-semiconductor (CMOS) image sensor or a charge-coupled device (CCD) image sensor), monochrome cameras, IR cameras, depth cameras, event-based cameras, and/or the like. In various implementations, the one or more image sensor systems 1614 further include illumination sources that emit light, such as a flash. In various implementations, the one or more image sensor systems 1614 further include an on-camera image signal processor (ISP) configured to execute a plurality of processing operations on the image data.

The memory 1620 includes high-speed random-access memory, such as DRAM, SRAM, DDR RAM, or other random-access solid-state memory devices. In some implementations, the memory 1620 includes non-volatile memory, such as one or more magnetic disk storage devices, optical disk storage devices, flash memory devices, or other non-volatile solid-state storage devices. The memory 1620 optionally includes one or more storage devices remotely located from the one or more processing units 1602. The memory 1620 includes a non-transitory computer readable storage medium.

In some implementations, the memory 1620 or the non-transitory computer readable storage medium of the memory 1620 stores an optional operating system 1630 and one or more instruction set(s) 1640. The operating system 1630 includes procedures for handling various basic system services and for performing hardware dependent tasks. In some implementations, the instruction set(s) 1640 include executable software defined by binary information stored in the form of electrical charge. In some implementations, the instruction set(s) 1640 are software that is executable by the one or more processing units 1602 to carry out one or more of the techniques described herein.

The instruction set(s) 1640 include a floor plan instruction set 1642 configured to, upon execution, obtain sensor data, provide views/representations, select sets of sensor data, and/or generate 3D point clouds, 3D meshes, 3D floor plans, and/or other 3D representations of physical environments as described herein. The instruction set(s) 1640 further include a keyframe instruction set 1644 configured to select keyframes that correspond to a given room that may be used to update the 3D meshes of that room as described herein. The instruction set(s) 1640 may be embodied as a single software executable or multiple software executables.

Although the instruction set(s) 1640 are shown as residing on a single device, it should be understood that in other implementations, any combination of the elements may be located in separate computing devices. Moreover, the figure is intended more as functional description of the various features which are present in a particular implementation as opposed to a structural schematic of the implementations described herein. As recognized by those of ordinary skill in the art, items shown separately could be combined and some items could be separated. The actual number of instructions sets and how features are allocated among them may vary from one implementation to another and may depend in part on the particular combination of hardware, software, and/or firmware chosen for a particular implementation.

It will be appreciated that the implementations described above are cited by way of example, and that the present invention is not limited to what has been particularly shown and described hereinabove. Rather, the scope includes both combinations and sub combinations of the various features described hereinabove, as well as variations and modifications thereof which would occur to persons skilled in the art upon reading the foregoing description and which are not disclosed in the prior art.

As described above, one aspect of the present technology is the gathering and use of sensor data that may include user data to improve a user's experience of an electronic device. The present disclosure contemplates that in some instances, this gathered data may include personal information data that uniquely identifies a specific person or can be used to identify interests, traits, or tendencies of a specific person. Such personal information data can include movement data, physiological data, demographic data, location-based data, telephone numbers, email addresses, home addresses, device characteristics of personal devices, or any other personal information.

The present disclosure recognizes that the use of such personal information data, in the present technology, can be used to the benefit of users. For example, the personal information data can be used to improve the content viewing experience. Accordingly, use of such personal information data may enable calculated control of the electronic device. Further, other uses for personal information data that benefit the user are also contemplated by the present disclosure.

The present disclosure further contemplates that the entities responsible for the collection, analysis, disclosure, transfer, storage, or other use of such personal information and/or physiological data will comply with well-established privacy policies and/or privacy practices. In particular, such entities should implement and consistently use privacy policies and practices that are generally recognized as meeting or exceeding industry or governmental requirements for maintaining personal information data private and secure. For example, personal information from users should be collected for legitimate and reasonable uses of the entity and not shared or sold outside of those legitimate uses. Further, such collection should occur only after receiving the informed consent of the users. Additionally, such entities would take any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices.

Despite the foregoing, the present disclosure also contemplates implementations in which users selectively block the use of, or access to, personal information data. That is, the present disclosure contemplates that hardware or software elements can be provided to prevent or block access to such personal information data. For example, in the case of user-tailored content delivery services, the present technology can be configured to allow users to select to “opt in” or “opt out” of participation in the collection of personal information data during registration for services. In another example, users can select not to provide personal information data for targeted content delivery services. In yet another example, users can select to not provide personal information, but permit the transfer of anonymous information for the purpose of improving the functioning of the device.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences or settings based on non-personal information data or a bare minimum amount of personal information, such as the content being requested by the device associated with a user, other non-personal information available to the content delivery services, or publicly available information.

In some embodiments, data is stored using a public/private key system that only allows the owner of the data to decrypt the stored data. In some other implementations, the data may be stored anonymously (e.g., without identifying and/or personal information about the user, such as a legal name, username, time and location data, or the like). In this way, other users, hackers, or third parties cannot determine the identity of the user associated with the stored data. In some implementations, a user may access their stored data from a user device that is different than the one used to upload the stored data. In these instances, the user may be required to provide login credentials to access their stored data.

Numerous specific details are set forth herein to provide a thorough understanding of the claimed subject matter. However, those skilled in the art will understand that the claimed subject matter may be practiced without these specific details. In other instances, methods apparatuses, or systems that would be known by one of ordinary skill have not been described in detail so as not to obscure claimed subject matter.

Unless specifically stated otherwise, it is appreciated that throughout this specification discussions utilizing the terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general-purpose computing apparatus to a specialized computing apparatus implementing one or more implementations of the present subject matter. Any suitable programming, scripting, or other type of language or combinations of languages may be used to implement the teachings contained herein in software to be used in programming or configuring a computing device.

Implementations of the methods disclosed herein may be performed in the operation of such computing devices. The order of the blocks presented in the examples above can be varied for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or value beyond those recited. Headings, lists, and numbering included herein are for ease of explanation only and are not meant to be limiting.

It will also be understood that, although the terms “first,” “second,” etc. may be used herein to describe various elements, these elements should not be limited by these terms. These terms are only used to distinguish one element from another. For example, a first node could be termed a second node, and, similarly, a second node could be termed a first node, which changing the meaning of the description, so long as all occurrences of the “first node” are renamed consistently and all occurrences of the “second node” are renamed consistently. The first node and the second node are both nodes, but they are not the same node.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

The foregoing description and summary of the invention are to be understood as being in every respect illustrative and exemplary, but not restrictive, and the scope of the invention disclosed herein is not to be determined only from the detailed description of illustrative implementations but according to the full breadth permitted by patent laws. It is to be understood that the implementations shown and described herein are only illustrative of the principles of the present invention and that various modification may be implemented by those skilled in the art without departing from the scope and spirit of the invention.

What is claimed is:

1. A method comprising:
at an electronic device having a processor:
obtaining sensor data of a physical environment that includes a plurality of rooms, the sensor data comprising images of the physical environment;
obtaining room boundary information associated with the physical environment, wherein the room boundary information is determined based on the sensor data;
identifying room-specific subsets of the sensor data based on the room boundary information; and
generating one or more geometric representations of the physical environment based on the room-specific subsets of the sensor data.

2. The method of claim 1, wherein identifying room-specific subsets of the sensor data based on the room boundary information comprises identifying a set of room-specific keyframes for each room of the plurality of rooms.

3. The method of claim 2, wherein the sensor data comprises first sensor data obtained for a first period of time, the method further comprising:
obtaining second sensor data for a second period of time, wherein the second sensor data corresponds to a first room of the plurality of rooms; and
in response to obtaining the second sensor data, updating the set of room-specific keyframes for the first room of the plurality of rooms.

4. The method of claim 3, further comprising:
updating a three-dimensional (3D) representation for the first room based on the updated set of room-specific keyframes.

5. The method of claim 1, further comprising:
determining a set of planes associated with each room of the plurality of rooms based on the room-specific subsets of the sensor data.

6. The method of claim 5, wherein determining the set of planes for each room comprises identifying a floor plane, a ceiling plane, and a wall plane for at least one or more walls of each room.

7. The method of claim 1, further comprising:
generating a three-dimensional (3D) representation of the physical environment based on the one or more geometric representations.

8. The method of claim 7, further comprising:
presenting a live view of the 3D representation on a display of the electronic device.

9. The method of claim 8, wherein the live view of the room comprises a floorplan that is produced while obtaining the sensor data.

10. The method of claim 1, wherein the images of the physical environment are based on at least one of live view images, ultra-wide view images that comprise a different view than the live view images, and semantically-labeled images corresponding to the live view images or the ultra-wide view images.

11. The method of claim 1, wherein the room boundary information is determined based on 3D semantic data that includes a 3D point cloud that includes semantic labels associated with at least a portion of 3D points within the 3D point cloud.

12. The method of claim 11, wherein the semantic labels identify walls, wall structures, objects, and classifications of the objects of each room.

13. A device comprising:
a non-transitory computer-readable storage medium; and
one or more processors coupled to the non-transitory computer-readable storage medium, wherein the non-transitory computer-readable storage medium comprises program instructions that, when executed on the one or more processors, cause the one or more processors to perform operations comprising:
obtaining sensor data of a physical environment that includes a plurality of rooms, the sensor data comprising images of the physical environment;
obtaining room boundary information associated with the physical environment, wherein the room boundary information is determined based on the sensor data;
identifying room-specific subsets of the sensor data based on the room boundary information; and
generating one or more geometric representations of the physical environment based on the room-specific subsets of the sensor data.

14. The device of claim 13, wherein identifying room-specific subsets of the sensor data based on the room boundary information comprises identifying a set of room-specific keyframes for each room of the plurality of rooms.

15. The device of claim 14, wherein the sensor data comprises first sensor data obtained for a first period of time, the method further comprising:
obtaining second sensor data for a second period of time, wherein the second sensor data corresponds to a first room of the plurality of rooms; and
in response to obtaining the second sensor data, updating the set of room-specific keyframes for the first room of the plurality of rooms.

16. The device of claim 15, wherein the non-transitory computer-readable storage medium comprises program instructions that, when executed on the one or more processors, further cause the one or more processors to perform operations comprising:
updating a three-dimensional (3D) representation for the first room based on the updated set of room-specific keyframes.

17. The device of claim 13, wherein the non-transitory computer-readable storage medium comprises program instructions that, when executed on the one or more processors, further cause the one or more processors to perform operations comprising:
determining a set of planes associated with each room of the plurality of rooms based on the room-specific subsets of the sensor data.

18. The device of claim 17, wherein determining the set of planes for each room comprises identifying a floor plane, a ceiling plane, and a wall plane for at least one or more walls of each room.

19. The device of claim 13, wherein the non-transitory computer-readable storage medium comprises program instructions that, when executed on the one or more processors, further cause the one or more processors to perform operations comprising:
generating a three-dimensional (3D) representation of the physical environment based on the one or more geometric representations; and
presenting a live view of the 3D representation on a display of the electronic device, wherein the live view of the room comprises a floorplan that is produced while obtaining the sensor data.

20. A non-transitory computer-readable storage medium, storing program instructions executable on a device to perform operations comprising:
obtaining sensor data of a physical environment that includes a plurality of rooms, the sensor data comprising images of the physical environment;
obtaining room boundary information associated with the physical environment, wherein the room boundary information is determined based on the sensor data;
identifying room-specific subsets of the sensor data based on the room boundary information; and
generating one or more geometric representations of the physical environment based on the room-specific subsets of the sensor data.
